(19) United States
(12) Patent Application Publication
(10) Pub. No.: US 2009/0129548 A1
(43) Pub. Date: May 21, 2009

(54) BEARING UNIT FOR ROTARY ANODES OF X-RAY TUBES

(76) Inventors: Wolfgang Kaika, Nuernberg (DE); Stefan Tritthart, Nuernberg (DE); Thomas Maussner, Nuernberg (DE)

Correspondence Address: COLLARD & ROE, P.C., 1077 NORTHERN BOULEVARD, ROSLYN, NY, 11576, US

(21) Appl. No.: 12/225,902

(22) PCT Filed: Apr. 3, 2007
(86) PCT No.: PCT/DE2007/075004

§ 371 Date: Dec. 18, 2008

(30) Foreign Application Priority Data
Apr. 4, 2006 (EP) 06007156.0

(51) Int. Cl. H01J 35/10; H01J 35/00

(52) U.S. Cl. 378/132; 378/144

(57) ABSTRACT

The invention relates to a bearing unit (1) for rotary anodes of X-ray tubes, with a shaft (2) and a flange element (3), to which a rotary anode can be attached, wherein the bearing unit (1) can be inserted into a cutout within the X-ray tube and locked there. The shaft (2) is held via a first and a second bearing element (4, 5), wherein the first bearing element (4) comprises an inner race (6) fitted on the shaft (2) and a separate outer ring (7). The second bearing element (5) comprises a roller bearing fitted on the shaft (2) with an inner ring (8) and an outer ring (9), wherein a spacer element (10) is fitted between the outer rings (7, 8) of the first and the second bearing element (4, 5).

The invention relates to a bearing unit for rotary anodes of x-ray tubes.

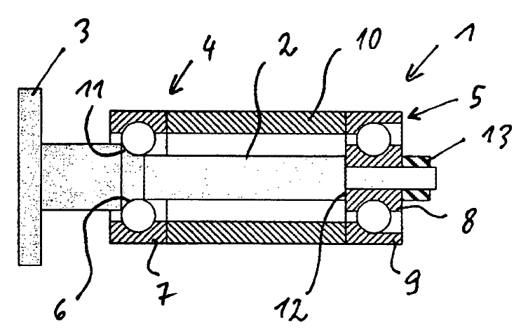

From DE 30 41 558 A1, for example in FIG. 1 of the drawings, a bearing unit for rotary anodes of x-ray tubes is known, wherein the rotary anode is accommodated in a partially illustrated evacuated glass bulb.

The object of the invention is to produce a bearing unit for rotary anodes of x-ray tubes of this type, which is particularly easy to assemble.

This object is attained with a bearing unit having the characterizing features of patent claim 1. Advantageous embodiments are specified in the dependent claims.

The bearing unit according to the invention, which has the characterizing features of patent claim 1, is compact in structure and consists of a small number of parts, which can be preassembled, so that the preassembled bearing unit can be inserted into the corresponding recess in the x-ray tube, in an easy-to-assemble fashion.

According to one advantageous embodiment, the shaft has a single-sided shoulder on its inner track, so that a separate inner ring of a roller bearing is no longer required. The single-sided shoulder can also absorb any axial forces that may occur.

According to a further advantageous embodiment, the inner ring of the roller bearing rests against a step on the shaft, and is thereby fixed in place in an axial direction, in an easy-to-assemble fashion.

By mounting the roller bearing using especially a form-fitting, tapered caulking element, once the bearing element has been attached to the shaft the roller bearing can be locked in position, thereby allowing the entire bearing unit to be fixed in place in a simple manner.

According to one advantageous embodiment, the outer ring of the first bearing element can be configured as a single-shoulder bearing, with the shoulder being located especially on the side that faces away from the flange element. This step serves to improve the ease of assembly of the bearing unit.

According to a further advantageous embodiment, the outer ring of the additional bearing element can also be configured as a single-shoulder bearing, so as to also achieve ease of assembly for the roller bearing.

Especially, the outer rings of the two bearing elements can be configured with single-shoulder bearings, wherein each of the shoulders is located on the inner side, facing the spacer element.

Configuring the first bearing element as a deep-groove ball bearing also makes it possible for the first bearing element to absorb axial forces to a certain extent.

According to a further advantageous embodiment, at least two spacer elements can be provided between the outer rings of the bearing elements, wherein, for example, a first (e.g., larger) spacer element, produced according to standard dimensions, can be used, and one or more spacer disks, produced according to precise measurements, can also be used to fill in the desired distance between the outer rings of the bearing elements.

The invention is specified in greater detail with reference to the exemplary embodiment represented in the drawing.

The represented bearing element 1 comprises a shaft 2 with a flange element 3, to which a rotary anode (e.g., according to DE 30 41 558 A1) can be attached.

The entire bearing unit 1 can then be inserted into a recess in the x-ray tube, provided for this purpose and not shown here, where it can be fixed in place in the customary manner (e.g., via screw attachment).

For accommodating the shaft 2, the bearing unit 1 has a first bearing element 4 and a second bearing element 5, wherein the first bearing element 4 has an outer ring 7 and the inner track 6 is located on the shaft 2.

The second bearing element 5 is formed by a roller bearing attached to the shaft 2, which bearing has an inner ring 8 and an outer ring 9. The outer rings 7 and 9 are spaced according to precise measurements via a spacer element 10.

As described, it is also possible for a plurality of spacer elements 10 to be provided (not shown).

The inner track 6 of the shaft 2 has a single-sided shoulder 11. The inner ring 8 of the roller bearing rests against the step 12 of the shaft 2.

The mounted bearing unit 1 is held in place via the attached caulking element 13.

### LIST OF REFERENCE SYMBOLS

1 Bearing unit
2 Shaft
3 Flange
4 First bearing element
5 Second bearing element
6 Inner track
7 Outer ring
8 Inner ring
9 Outer ring
10 Spacer element
11 Shoulder
12 Step
13 Caulking element

1. Bearing unit (1) for rotary anodes of x-ray tubes, with a shaft (2) and a flange element (3), to which a rotary anode can be attached, wherein
the bearing unit (1) can be inserted into a recess inside the x-ray tube, where it can be fixed in place,
the shaft (2) is held by a first and a second bearing element (4, 5), wherein
the first bearing element (4) is comprised of an inner track (6) mounted on the shaft (2), and of a separate outer ring (7),
the second bearing element (5) is comprised of a roller bearing attached to the shaft (2), with an inner ring (8) and an outer ring (9), wherein
a spacer element (10) is fitted between the outer rings (7, 8) of the first and the second bearing element (4, 5).

2. Bearing unit (1) according to claim 1, wherein the inner track (6) mounted on the shaft (2) has a single-sided shoulder (11).

3. Bearing unit (1) according to claim 1, wherein the inner ring (8) of the roller bearing rests against a step (12) of the shaft (2).

4. Bearing unit (1) according to claim 1, wherein the roller bearing is fastened to the shaft (2) via a caulking element (13).

5. Bearing unit (1) according to claim 1, wherein the outer ring (7) is configured as a single-shoulder bearing.

6. Bearing unit (1) according to claim 1, wherein the outer ring (9) is configured as a single-shoulder bearing.

7. Bearing unit (1) according to claim 1, wherein the first bearing element (4) is configured as a deep-groove ball bearing.

8. Bearing unit (1) according to claim 1, wherein at least two spacer elements (10) are provided between the outer rings (7, 8) of the first and the second bearing element (4, 5).
